(19) United States
(12) Patent Application Publication
(10) Pub. No.: US 2026/0188762 A1
(43) Pub. Date: Jul. 2, 2026

(54) BATTERY MONITORING SYSTEM AND A METHOD THEREOF

(71) Applicant: VOCAI LTD, Hod Hasharon (IL)

(72) Inventors: Yehuda SHEN BAHAR, Rehovot (IL); William KOPELOVICH, Ramat Gan (IL); Shai GEPSHTEIN, Hod Hasharon (IL); Nimrod HARPAK, Nes Ziona (IL)

(73) Assignee: VOCAI LTD, Hod Hasharon (IL)

(21) Appl. No.: 19/005,431

(22) Filed: Dec. 30, 2024

(51) Int. Cl. H01M 10/42

(52) U.S. Cl. CPC H01M 10/425; H01M 10/4228; H01M 2010/4271; H01M 2010/4278

(57) ABSTRACT

A system and method of the device may include at least one gas sensor mounted in proximity to a battery. In addition, the device may include a front-end electronic (FEE) configured to continuously acquire signals from the at least one gas sensor and convert the acquired signals into corresponding gas measurements. The device may include a processor coupled by a memory module configured to determine battery health indications based, in part, on the gas measurements compared to a combination of thresholds, where the battery health indications and the combination of thresholds are retained in the memory module.

### TECHNICAL FIELD

The present disclosed subject matter relates to batteries. More particularly, the present disclosed subject matter relates to monitoring and management techniques based on a sensing analysis of gases and other physical characteristics.

### BACKGROUND

With the rapid growth of battery-powered devices and energy storage solutions across modern industries, concerns regarding battery safety have significantly intensified, particularly around the phenomenon of thermal runaway. This event occurs when a battery cell experiences an uncontrolled increase in temperature, triggering a series of exothermic reactions that can lead to overheating, cell rupture, and in extreme cases, explosions.

As battery utilization increases across various sectors, such as electric vehicles (EVs), consumer electronics, and renewable energy storage systems, the risks associated with thermal runaway have become a critical safety concern. The proliferation of lithium-ion batteries in energy-intensive applications like electric vehicles, large-scale energy storage, and portable electronics has led to a focus on maximizing energy density and performance.

While these advancements improve efficiency, they also introduce higher thermal and electrical stresses on battery systems, increasing the likelihood of thermal runaway. Short circuits caused by internal defects, damage, or improper handling can result in rapid heating within a battery cell. In lithium-ion batteries, if the generated heat exceeds the dissipation rate, decomposition reactions within the electrolyte and electrodes can further raise the temperature, potentially triggering thermal runaway.

Batteries, especially those used in electric vehicles and energy storage systems, are susceptible to thermal runaway if not carefully monitored during charging and discharging. Overcharging can lead to lithium deposition on the anode, which may cause a short circuit, while undercharging can damage the internal structure of the battery, increasing the risk of runaway reactions. Additionally, external mechanical damage, such as impacts or punctures, can compromise a battery's structure, leading to internal short circuits.

Once thermal runaway begins, the battery can rapidly heat up, releasing flammable gases that may ignite or cause an explosion. This risk is especially significant in densely packed battery cells, where the failure of one cell can propagate thermal runaway to adjacent cells in a domino effect. Moreover, thermal runaway in lithium-ion batteries releases harmful gases like hydrogen fluoride (HF) and carbon monoxide (CO), which pose serious health risks if exposed to or inhaled.

In closed environments like homes, offices, or vehicles, these emissions can be particularly dangerous. Battery fires resulting from thermal runaway are notoriously difficult to extinguish and can cause significant property damage. The intense heat and fire typically require specialized firefighting equipment and protocols.

As battery usage grows, mitigating these risks is crucial. Safety improvements in design and protocols remain essential to ensure reliable battery operation in both daily and industrial applications.

Therefore, it is the objective of the present disclosure to provide an advanced battery management solution that offers an early indication of potential failure and thermal runaway.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by a data processing apparatus, cause the apparatus to perform the actions.

In one general aspect, the battery monitoring system may include at least one gas sensor mounted in proximity to a battery. Battery monitoring systems may also include a front-end electronic (FEE) configured to continuously acquire signals from the at least one gas sensor and convert the acquired signals into corresponding gas measurements. The system may furthermore include a processor coupled by a memory module configured to determine battery health indications based, in part, on the gas measurements compared to a combination of thresholds, where the battery health indications and the combination of thresholds are retained in the memory module. Other embodiments of this aspect include corresponding computer systems, apparatus, and computer programs recorded on one or more computer storage devices, each configured to perform the actions of the methods.

In one general aspect, the method may include acquiring signals from at least one gas sensor mounted in proximity to a battery. The method may also include converting the signals into corresponding gas measurements. The method may furthermore include determining a range of battery health indications based on gas measurements compared to a combination of thresholds. Method may in addition include providing the battery health indications to at least a battery management system. Other embodiments of this aspect include corresponding computer systems, apparatus, and computer programs recorded on one or more computer storage devices, each configured to perform the actions of the methods.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosure will be apparent from the following detailed description taken in conjunction with the accompanying drawings.

In the drawings:

FIG. 1A shows a block diagram of a monitoring system, in accordance with some of the disclosed embodiments.

FIG. 1B shows an arrangement of where the monitoring system is mounted in an array of batteries.

FIG. 2 shows a flowchart diagram of a monitoring and management method, in accordance with some of the disclosed embodiments.

### DETAILED DESCRIPTION

The embodiments disclosed are only examples of the many possible advantageous uses and implementations of the innovative teachings presented. In general, statements made in the specification of the present application do not necessarily limit any of the various claimed embodiments. Moreover, some statements may apply to some inventive features but not to others. In general, unless otherwise indicated, singular elements may be plural and vice versa with no loss of generality. In the drawings, like numerals refer to like parts through several views.

The objective of the present disclosure is to provide a system and method for battery health monitoring aimed at evaluating the condition of a battery or an array of batteries across various levels, from normal to critical states. By detecting these states, the system ensures safe operation and prevents battery failures through timely identification and classification of potential issues, offering essential insights for maintaining battery safety and efficiency.

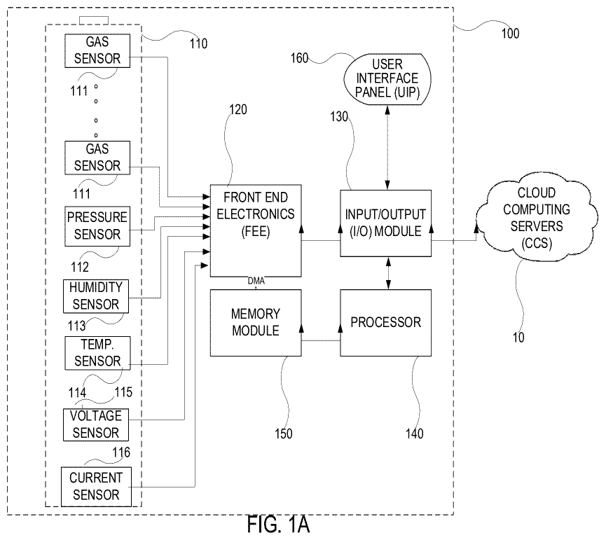

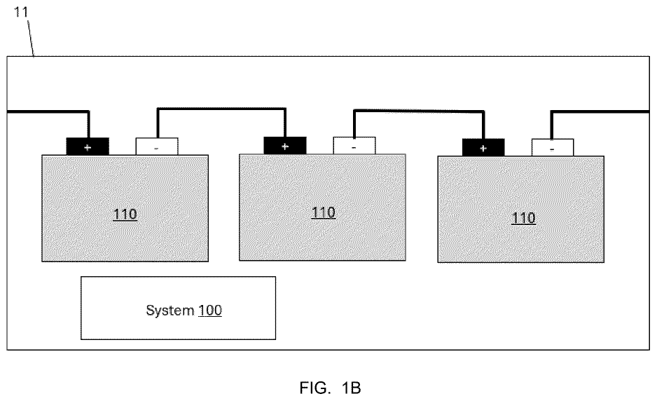

FIG. 1 shows a block diagram of a monitoring system (system) 100, in accordance with some of the disclosed embodiments.

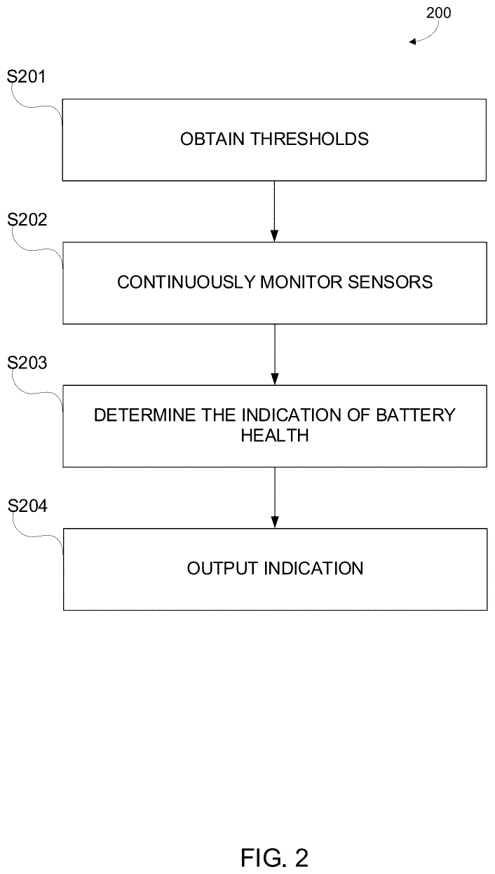

System 100 may be a computerized apparatus adapted to perform methods such as depicted in FIG. 2. In some embodiments, system 100 may include: a plurality of environmental and operational sensors (sensors) 110, a front-end electronic (FEE) module 120, an input/output module (I/O) 130, a processor 140, and a memory module (memory) 150. In an optional configuration, system 100 may include a user interface panel (UIP) 160. Alternatively, a UIP 160 may communicate with a battery management system (BMS), providing the same signals indicative of a battery status. A BMS is an electronic system that ensures safe, efficient operation of rechargeable batteries. The BMS monitors key parameters like voltage, current, and temperature, protects against issues like overcharging and overheating, balances cells to extend battery life, and communicates with other devices. BMS is essential for safe operation and optimizing performance in applications such as electric vehicles, energy storage, and other electronics.

In certain embodiments, system 100 can be integrated into a BMS device.

In some embodiments, system 100 is adapted to communicate with a cloud computing server (CCS) 10. Such communication may be achieved directly or via the BMS. Direct communication may be achieved by a network interface card (NIC), not shown, that may be included or integrated with system 100. The communication with the CCS can be established over a network (not shown), such as a local area network (LAN), a wide area network (WAN), the Internet, a private network, a proprietary link, and the like.

As illustrated in FIG. 1B, in some embodiments, system 100 can be mounted in substantially close proximity to an array of batteries 11, preferably within the same enclosure.

It should be understood that the term “battery” in this disclosure also refers to an array of batteries, individual battery cells, arrays of battery cells, and any combination thereof, or the like.

Processor 140 may be a central processing unit (CPU), a microprocessor, an electronic circuit, an integrated circuit (IC), a graphical processing unit (GPU), a tensor processing unit (TPU), or the like. Additionally, or alternatively, system 100 can be implemented as firmware written for or ported to a specific processor such as a digital signal processor (DSP) or microcontroller or can be implemented as hardware or configurable hardware such as field programmable gate array (FPGA) or application specific integrated circuit (ASIC). Processor 140 may be utilized to perform computations required by System 100 or any of its subcomponents.

In some embodiments, memory 150 may be comprised of volatile and/or non-volatile memories, based on technologies such as semiconductor, magnetic, optical, flash, a combination thereof, or the like. For example, memory 150 can be a flash disk, a random-access memory (RAM), a memory chip; a semiconductor storage device such as a flash device, a memory stick, or the like.

In some exemplary embodiments, memory 150 may retain program code to activate processor 140 to perform acts associated with any of the steps shown in FIG. 2. Memory 150 may also be used to retain digital information of sensor readings acquired by FEE 120. In some embodiments, the components detailed below may be implemented as one or more sets of interrelated computer instructions, executed for example by processor 140 or by another processor. The components may be arranged as one or more executable files, dynamic libraries, static libraries, methods, functions, services, or the like, programmed in any programming language and under any computing environment.

In some embodiments, at least one dynamic library may include an updatable machine learning battery health model used by processor 140 for sensor 110 readings to infer system status.

In some embodiments, system 100 may utilize I/O 130 as an interface to transmit and/or receive information and instructions between system 100 and components such as FEE 120, CCS 10 via the Internet, or similar connections. In some exemplary embodiments, I/O 130 may be used to provide an interface for a user of the system, such as by delivering outputs, visualized results, reports, or the like through UIP 160. It will be appreciated that system 100 can operate without human intervention.

The UIP 160 is a unit that provides visual and/or audible indications, determined by processor 140, of the status or performance of system 100. In some embodiments, it may function as an alarm by generating warning signals or alerts in response to abnormal conditions, acting as a signaling device to indicate system status. UIP 160 may also include status indicators, such as lights, to show whether the system is operating normally or encountering issues, with sensors, such as sensors 110, providing specific battery health indications. Additionally, or alternatively, UIP 160 may feature at least one indicator, such as a light or gauge, and at least one display module, such as an LCD screen or LED panel, and any combination thereof, or the like.

Additionally, or alternatively, when the UIP 160 is not implemented, system 100 can use an auxiliary interface to communicate the BMS. The BMS receives signals from system 100 indicative of the battery status and can take some actions, such as alerting the user, taking actions to prevent overcharging, over-discharging, overheating, short circuits, and the like.

CCS 10 may be a cloud computing server that is deployed in a cloud computing environment. The cloud computing environment may include a private cloud, a public cloud, and a hybrid cloud. Examples of a public cloud may include Amazon® Web Services (AWS), Microsoft Azure®, a Google® cloud platform, and the like. CCS 10 may be realized as a physical server, a virtual machine, a software container, a serverless function, or the like.

CCS 10 remotely stores, processes, and manages data and applications, enabling multiple monitoring systems 100 to access and use them over the internet. In some embodiments, CCS 10 handles tasks such as storing sensor readings, indications, and system statuses from multiple systems 100 and running machine learning applications to generate models for calibrating system status inference based on this information. Additionally, CCS 10 may receive other measurements (such as voltage, temperature, and current) from the OEM cloud server. CCS 10 also generates insights into battery status and provides operational recommendations. A user interface may be available on CCS 10, allowing customers to view their battery data. Data will automatically be sent back to the client cloud, with minimal need for user interactions.

FEE 120 is designed for synchronized data acquisition, enabling continuous monitoring of system 100. In some embodiments, FEE 120 may be implemented as electronic circuitry incorporating an analog-to-digital converter (ADC) to acquire electrical signals from sensors 110. The ADC is configured to obtain multiple electrical signals from sensors 110 in real time, simultaneously converting the signals from various sensors into digital information. The ADC processes multiple sensor inputs, capturing sensor values, and storing the digital representation of sensors 110 in memory 150 via I/O 130 and processor 140. Additionally, or alternatively, FEE 120 may be designed to store data directly into memory 150 via a direct memory access (DMA) bus.

Sensors 110 transduce physical, chemical, or environmental properties into measurable electrical signals proportional to changes detected in those properties. In some embodiments, sensors 110 include at least one gas sensor 111. Other examples of sensors that can be included in system 100 are at least one pressure sensor 112, at least one humidity sensor 113, at least one temperature sensor 114, at least one voltage sensor 115, and at least one current sensor 116. It will be appreciated that a portion of sensors 110 are mounted in substantially close proximity to the battery or an array of batteries 11.

Gas sensor 111 may be a component that detects the presence or concentration of a particular gas in the environment of the battery or an array of batteries 11. In some embodiments, the output of a gas sensor 111 (φ) is an electrical signal proportional to the gas concentration detected by the sensor.

In some embodiments, gas sensor 111 may be a hydrogen (H₂) sensor, such as a metal oxide semiconductor (MOS) hydrogen sensor, an electrochemical hydrogen sensor, a palladium-based hydrogen sensor, or any combination thereof, and the like. It should be noted that a gas sensor 111 can be implemented using other techniques.

In some embodiments, gas sensor 111 may be a solvent (SOL) gas sensor that detects electrolyte vapors using, for example, a photoionization detector, MOS VOCs sensor, or electrochemical volatile organic compound sensor.

In some embodiments, gas sensor 111 may be a carbon monoxide (CO) sensor, such as an electrochemical CO sensor or MOS CO sensor.

In some embodiments, gas sensor 111 may be a carbon dioxide (CO₂) sensor, such as a non-dispersive infrared CO₂ sensor or electrochemical CO₂ sensor.

In some embodiments, gas sensor 111 may be a volatile organic compounds (VOCs) sensor, such as a photoionization detector, MOS VOC sensor, or catalytic bead sensor.

Additionally, or alternatively, sensors 110 may include a plurality of gas sensors 111 selected from the group including hydrogen (H₂) sensors, electrolyte vapors sensors, CO sensors, CO₂ sensors VOCs sensors, and any combination thereof, or the like.

Pressure sensor 112 may be a component that measures the force exerted by gases in a chamber or enclosure housing the battery or an array of batteries 11. The output of pressure sensor 112 (ψ) is an electrical signal proportional to the pressure and may be measured in PSI or other conventional pressure units.

Humidity sensor 113 may be a component that measures the relative humidity (RH) or absolute humidity (AH) of the air surrounding the battery or an array of batteries 11. The output of humidity sensor 113 (η) is an electrical signal proportional to the humidity and may be measured in grams of water vapor per cubic meter of air (g/m³), or conventional humidity units, or percentage thereof.

Temperature sensor 114 may be a component that measures the temperature of the battery, an array of batteries 11, the environment surrounding the batteries or any combination thereof, or the like. The output of temperature sensor 114 (θ) is an electrical signal proportional to the temperature and may be measured in degrees Celsius or other conventional temperature units.

Voltage sensor 115 may be a component that measures the DC voltage of either each battery 110, an array of batteries 11, or a plurality of batteries. The output of voltage sensor 115 (ν) is an electrical signal proportional to the voltage and may be measured in volts or other conventional voltage units.

Current sensor 116 may be a component that measures the current of either each sys, an array of batteries 11, or a plurality of batteries. The output of current sensor 116 (i) is an electrical signal proportional to the current and may be measured in amperes or other conventional current units.

FIG. 2 shows a flowchart diagram of a monitoring and management method (method) 200, in accordance with some of the disclosed embodiments.

In an embodiment, method 200, executed by system 100, is a battery health monitoring process provided for evaluating the condition of a battery or an array of batteries across multiple levels, ranging from normal to critical states. In some embodiments, method 200 determines specific health indications, including standard operation, degraded performance, onset of heating, elevated temperatures, undercharged conditions, critical temperatures, and thermal runaway. By identifying these states, system 100 and method 200, which activate it, cause safe operation and help users prevent battery failures. This is done through timely detection and classification of potential issues, providing crucial information for maintaining battery safety and efficiency.

In S201, thresholds (T) may be obtained. In some embodiments, the thresholds include a set of thresholds, each corresponding to a different sensor from the plurality of sensors 110. Such a set of thresholds may be a combination of any subset of thresholds from a set of predefined thresholds. In an embodiment, each set includes multiple thresholds (T), with each threshold associated with a different level of indication. For example, T1, T2, . . . Tn, where T1 is associated with a normal indication state and Tn with the critical indication state. In an embodiment, thresholds (T) may be predetermined.

In some embodiments, the set of thresholds may be obtained from a dynamic library of memory 150 (of FIG. 1), Additionally, or alternatively, the set of thresholds may be obtained from CCS 10. It should be noted that the set of thresholds is an outcome of the machine learning battery health model used by processor 140 (of FIG. 1) for sensors 110 (of FIG. 1) readings to infer (calibrate) the indications level.

It will be appreciated that the sets of thresholds are predetermined by CCS 10 or processor 140 and serve as a baseline for processor 140 for evaluating the digital information of sensors' 110 signal measurements. In some embodiments, CCS 10 can be utilized for training the model based on signal measurements (e.g., sensors' readings) received from a plurality of systems (not shown) deployed in a plurality of different batteries.

In some example embodiments, the process described with reference to FIG. 2 involves inferring sensor readings, labeled as Φ, ψ, η, θ, i, and ν, against predetermined thresholds (T) associated with these sensor readings. These predetermined thresholds may be established by a machine-learning battery health model trained on a dataset of sensor readings, where each input reading is paired with the correct output labels. Specifically, the labeling includes which combination of sensor readings can lead to one of the seven indications, particularly the onset of heating indication (referenced as T3). The model can be trained differently for various types of batteries. Once trained, the model is deployed in CCS 10 (of FIG. 1) and updated to system 100 during battery operation. The model can be improved as more datasets are labeled, allowing a new model to be pushed to system 100. Iteratively adjusting the model parameters minimizes the error between the predicted output and the true labels

Additionally, or alternatively, the predetermined thresholds can be enriched with metadata related to the environment (e.g., ambient temperature and humidity), the battery type, the battery's lifetime, and the device or vehicle in which the battery is installed

In some embodiments, the machine learning battery health model can be implemented using networks and algorithms such as decision trees, linear regression, and neural networks. It should be noted that the disclosed process can also be realized using semi-supervised machine learning.

In S202, the sensors may be continuously monitored. In some embodiments, the output from each sensor in sensor 110 is an electrical signal that is converted into a digital information by FEE 120, which also synchronizes data acquisition with processor 140, capturing sensor values in real time and storing the digital data.

In S203, the indication of battery health may be determined. In some embodiments, a monitoring system, such as system 100 of the present disclosure is configured to determine a plurality of indication levels that monitor the health of a battery or an array of batteries 11, ranging from normal to severe conditions.

The following are seven indications (but not limited to these) in an exemplary embodiment: standard battery indication (referenced to T1), degraded battery indication (referenced to T2), onset of heating indication (referenced to T3), elevated temperature indication (referenced to T4), overcharge or undercharged indication (referenced to T5), critical temperature indication (referenced to T6), battery cell vent, electrolyte leakage, and thermal runaway indication (referenced to T7).

In a standard battery indication, the battery is functioning optimally with no significant issues. All parameters, including temperature, voltage, and state of charge, are within the expected range. The battery is operating as intended, providing reliable performance. In some embodiments, this indication is realized if the following conditions are true T1L_{SOL}≤φ_{SOL}≤T1U_{SOL}; T1L_{H}≤φ_{H}≤T1U_{H}; T1L_{VOC}≤φ_{VOC}≤T1U_{VOC}; T1L_{CO2}≤φ_{CO2}≤T1H_{CO2}; and any combination thereof.

It will be understood that φ_{SOL} (for example) represents the measured concentration of a solvent (SOL) gas, while T1L_{SOL} (for example) is the predetermined lower threshold for that solvent gas. It should be noted that all the following conditions are based on the format where φ indicates the measured gas concentration, with the subscript specifying the gas name. Similarly, T1 to T7 represent different predetermined indications (described above), with their subscripts indicating the specific gases to which they are associated. In a degraded battery indication, the battery shows signs of aging or wear, with reduced capacity or efficiency. It should be noted that the ranges of thresholds can be overlapped.

It may have a lower state of charge retention, increased internal resistance, minor temperature fluctuations, internal shorts, loss of electrolyte or lithium plating. The battery can still function but at a reduced performance level. In some embodiments, this indication is realized if the following conditions are true T2L_{SOL}≤φ_{SOL}≤T2H_{SOL}; T2L_{H}≤φ_{H}≤T2U_{H} ; T2L_{VOC}≤φ_{VOC}≤T2U_{VOC}; T2L_{CO2}≤φ_{CO2}≤T2H_{CO2}; and any combination thereof.

The onset of heating indication points out initial signs of abnormal heat generation are detected, which may point out an increased internal resistance or inefficient energy conversion. In such cases, monitoring is advised to ensure that temperature does not escalate further. In some embodiments, this indication is realized if the following conditions are true T3L_{SOL}≤φ_{SOL}≤T3U_{SOL}; T3L_{H}≤φ_{H}≤T3U_{H}; T3L_{VOC}≤φ_{VOC}≤T3U_{VOC}; T3L_{CO2}≤φ_{CO2}≤T3U_{CO2}; and any combination thereof.

The elevated temperature indicates that the battery's temperature has reached an elevated level, ranging between 90° C. and 100° C. This range suggests that the battery is experiencing significant thermal stress, which may affect performance and safety. In such a case, immediate action may be required to prevent further escalation. In some embodiments, this indication is realized if the following conditions are true 90° C.≤θ≤100° C.∧{T4L_{SOL}≤φ_{SOL}≤T4U_{SOL}; T4L_{H}≤φ_{H}≤T4U_{H}; T4L_{VOC}≤φ_{VOC}≤T4U_{VOC}; T4L_{CO2}≤φ_{CO2}≤T4U_{CO2}; and any combination thereof, or the like}.

The overcharge and undercharged indication suggests battery works outside of its recommended voltage range. In this condition, a battery cell might experience increased risk and degradation, warranting careful monitoring to prevent further issues. In some embodiments, this indication is realized if the following conditions are true T5L_{SOL}≤φ_{SOL}≤T5U_{SOL}; T5L_{H}≤φ_{H}≤T5U_{H}; T5L_{VOC}≤φ_{VOC}≤T5U_{VOC}; T5L_{CO2}≤φ_{CO2}≤T5U_{CO2}; and any combination thereof.

In the critical temperature indication, the battery's temperature has reached a critical range of 130° C. to 150° C., indicating severe overheating. This level poses a significant risk of thermal damage to the battery, potentially leading to permanent damage or a dangerous situation if left unaddressed. In some embodiments, this indication is realized if the following conditions are true: 130° C.≤θ≤150° C.∧{T6L_{SOL}≤φ_{SOL}≤T6U_{SOL}; T6L_{H}≤φ_{H}≤T6U_{H}; T6L_{VOC}≤φ_{VOC}≤T6U_{VOC}; T6L_{CO2}≤φ_{CO2}≤T6U_{CO2} and any combination thereof}

The thermal runaway indicator points out that the battery has entered an uncontrollable self-heating state, where the internal temperature that may be preceded by venting rises rapidly. This condition can lead to venting, leakage, or explosion if not managed immediately. It represents the most severe failure mode, requiring emergency intervention. In some embodiments, this indication is realized if the following conditions are true T7L_{SOL}≤φ_{SOL}≤T7U_{SOL}; T7L_{H}≤φ_{H}≥T7U_{H}; T7L_{VOC}≤φ_{VOC}≤T7U_{VOC}; T7L_{CO2}≤φ_{CO2}≥T7U_{CO2}; and any combination thereof.

In S204, an indication may be output. In some embodiments, the indication may be output to UIP 160 (of FIG. 1) to provide visual and/or audible indications of the monitoring system's status as determined by processor 140. The indication can be manifested as an alarm buzzer, alarm lights, gauges, display modules such as LCD screens or LED panels, Geoinformation, or other digital telemetries, offering specific feedback of system 100. In an embodiment, the indications can be sent or fed to a BMS device.

During inference, the trained model processes input data and generates predictions or classifications based on the sensor readings learned during training. That is, S204 may include classifying, based on the trained model, sensors' readings into one of the seven indications mentioned above. The inference phase may include preprocessing the sensor readings (considered as features) to normalize or scale such features

The embodiments disclosed herein can be implemented as hardware, firmware, software, or any combination thereof. The application program may be uploaded to, and executed by, a machine comprising any suitable architecture. Preferably, the machine is implemented on a computer platform having hardware such as one or more central processing units (“CPUs”), a memory, and input/output interfaces.

The computer platform may also include an operating system and microinstruction code. The various processes and functions described herein may be either part of the microinstruction code or part of the application program, or any combination thereof, which may be executed by a CPU, whether or not such computer or processor is explicitly shown.

In addition, various other peripheral units may be connected to the computer platform such as an additional network fabric, storage unit, and a printing unit. Furthermore, a non-transitory computer-readable medium is any computer-readable medium except for a transitory propagating signal.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to the first and second elements does not mean that only two elements may be employed there or that the first element must precede the second element in some manner. Also, unless stated otherwise, a set of elements includes one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosure and the concepts contributed by the inventor to further the art and are to be construed as being without limitation to such specifically recited examples and conditions.

What is claimed is:

1. A battery monitoring system, comprising:
at least one gas sensor mounted in proximity to a battery;
a front-end electronic (FEE) configured to continuously acquire signals from the at least one gas sensor and convert the acquired signals into corresponding gas measurements; and
a processor coupled by a memory module configured to determine battery health indications based, in part, on the gas measurements compared to a combination of thresholds, wherein the battery health indications and the combination of thresholds are retained in the memory module.

2. The system of claim 1, further comprising: a plurality of sensors, wherein the plurality of sensors includes environmental and operational sensors.

3. The system of claim 2, wherein the plurality of sensors further comprises any one of:
at least one pressure sensor;
at least one humidity sensor;
at least one temperature sensor; and
at least one voltage sensor.

4. The system of claim 3, wherein the processor is further configured to determine the battery health indications based on sensor measurements with respect to the combination of thresholds.

5. The system of claim 3, wherein one or more sensors of the plurality of sensors are mounted in substantially close proximity to the battery.

6. The system of claim 1, wherein the memory module also retains program code used to determine the battery health indications and the sensors measurements.

7. The system of claim 1, wherein the processor is further configured to determine the battery health indication levels ranging from normal to severe conditions.

8. The system of claim 1, wherein the processor is further configured to: communicate the plurality of battery health indication levels to a battery management system (BMS).

9. The system of claim 1, further comprising: an input-output module configured to communicate with a cloud computing server (CCS) to obtain at least one of: the predetermined thresholds, sensor measurements, and the determined battery health indications.

10. The system of claim 2, wherein the predetermined thresholds comprise a plurality of sets of thresholds, each set comprising multiple thresholds, wherein each set corresponds to a sensor in the plurality of sensors and the at least one gas sensor, and wherein each threshold within a set is associated with a distinct indication level.

11. The system of claim 1, wherein the combination of thresholds is derived from a battery health model, wherein the battery health model is a machine learning model trained based on a type of the battery being monitored.

12. The battery monitoring system of claim 1, wherein at least one gas sensor detects the presence or concentration of a particular gas in the environment of the battery.

13. A method for battery health monitoring, comprising:
acquiring signals from at least one gas sensor mounted in proximity to a battery;
converting the signals into corresponding gas measurements;
determining a range of battery health indications based on gas measurements compared to a combination of thresholds; and
providing the battery health indications to at least a battery management system.

14. The method of claim 13, further comprising: acquiring the signals from a plurality of sensors connected in proximity to the battery.

15. The method of claim 14, wherein the plurality of sensors further comprises:
at least one pressure sensor;
at least one humidity sensor;
at least one temperature sensor; and
at least one voltage sensor.

16. The method of claim 14, further comprising: determining the battery health indications based on sensor measurements with respect to the combination of thresholds.

17. The method of claim 14, further comprising: determining the battery health indication levels ranging from normal to severe conditions.

18. The method of claim 14, further comprising: obtaining a combination of thresholds from a cloud computing server (CCS).

19. The method of claim 18, wherein the combination of thresholds is derived from a battery health model, wherein the battery health model is a machine learning model trained based on a type of the battery being monitored.

20. The method of claim 14, wherein the predetermined thresholds comprise a plurality of sets of thresholds, each set comprising multiple thresholds, wherein each set corresponds to a sensor in the plurality of sensors and the at least one gas sensor, and wherein each threshold within a set is associated with a distinct indication level.

21. The method of claim 20, wherein the predetermined thresholds further comprise metadata related to environmental conditions, battery type, battery lifetime expectancy, and the device in which the battery is installed.

22. The method of claim 13, wherein at least one gas sensor detects the presence or concentration of a particular gas in the environment of the battery.
